(19) United States
(12) Patent Application Publication
(10) Pub. No.: US 2026/0273706 A1
(43) Pub. Date: Sep. 17, 2026

(54) Sensor Guided Tool Bit Selection and Engagement Mechanism and Method

(71) Applicant: Omni Instrument LLC, San Francisco, CA (US)

(72) Inventor: Raghav Jalan, San Francisco, CA (US)

(21) Appl. No.: 19/076,593

(22) Filed: Mar. 11, 2025

(51) Int. Cl. B25B 21/00; B25F 5/02

(52) U.S. Cl. CPC B25B 21/007; B25F 5/021

(57) ABSTRACT

A sensor equipped power tool has a housing that at least partially surrounds a movable engagement mechanism supported by the housing. The movable engagement mechanism is movable between a first and a second position. The housing also holds a tool bit holder able to support a plurality of tool bits, with each tool bit individually engageable by the movable engagement mechanism in a first position. A sensor supported by the housing is able to provide information to a control system, with the control system guiding selection and engagement of a tool bit by the movable engagement mechanism. The movable engagement mechanism can move into the second position to allow engagement of the tool bit with potentially engageable parts.

### TECHNICAL FIELD

The present technology relates to a sensor equipped power tool able to support selection, engagement, and release of tool bits, including screw, drill, and other rotary or impact tool bits.

### BACKGROUND

Most manufacturing or construction tasks require employment of many different tools and parts such as screws, nuts, bolts, fasteners, connectors, rivets, pins, clips or the like. Unfortunately, identifying a needed part and switching between various tools or tool tips needed to engage with that part can slow work and cause much inconvenience. For example, simply drilling a hole in material and tightening a screw can require use of two separate power tools (one for drilling a hole in the material and one for driving a screw), or alternatively can require time consuming switching between a drill bit and screw tip. Additionally, there are many instances when an incorrectly sized or otherwise inappropriate tool tip is manually selected to engage with the part, resulting in wasted time required to remove and replace the tool tip.

What is needed is a sensor equipped power tool able to identify a part and select an appropriate tool tip. Ideally, such a power tool can hold and allow automatic switching between tool tips with no or limited manual engagement.

### SUMMARY

Disclosed herein are various structural embodiments and operational features for a sensor equipped power tool. In one embodiment a housing at least partially surrounds a movable engagement mechanism supported by the housing. The movable engagement mechanism is movable between a first and a second position. The housing also holds a tool bit holder able to support a plurality of tool bits, with each tool bit individually engageable by the movable engagement mechanism in a first position. A sensor supported by the housing is able to provide information to a control system, with the control system guiding selection and engagement of a tool bit by the movable engagement mechanism. The movable engagement mechanism can move into the second position to allow engagement of the tool bit with potentially engageable parts.

In some embodiments, the housing defines a pistol grip.

In some embodiments, the movable engagement mechanism is linearly movable.

In some embodiments, the movable engagement mechanism is rotationally movable.

In some embodiments, the tool bit holder is a rotatable plate.

In some embodiments, the tool bit holder can hold at least one of a screw bit and a drill bit.

In some embodiments, the sensor is supported by the housing.

In some embodiments, the sensor is a camera positioned to detect potentially engageable parts.

In some embodiments, the sensor is a camera positioned to detect construction materials.

In some embodiments, a method of operating a sensor equipped power tool, includes the steps of using sensor information to determine engageable parts geometry and allow selection of a corresponding tool bit. A tool bit holder can be movable to a position allowing engagement of a tool bit by the movable engagement mechanism. The tool bit holder can then be moved to another position allowing use of the tool bit.

In some embodiments, the sensor equipped power tool can set a torque profile.

In some embodiments, the sensor equipped power tool can determine likely torque applied by the tool bit to a part, and adjust applied torque as the part is driven into material.

In some embodiments, the sensor equipped power tool can use computation supported by the sensor equipped power tool to determine torque profile, rotation direction, speed profile, drilling depth or download data related to operation of the sensor equipped power tool, and use downloaded data relevant to assembly to set at least one of tool bit selection, applied torque, speed, and drilling depth.

In some embodiments, the sensor equipped power tool can collect data related to user operation of the sensor equipped power tool from at least one of users to users, manufacturers to users, and users to manufacturers, and share at least some user operational data with others.

In some embodiments, a method of operating a sensor equipped power tool, includes the steps of moving a tool bit holder to a position allowing engagement of a tool bit by the movable engagement mechanism. The tool bit holder can be moved to another position allowing use of the tool bit. Sensor information and feedback can be used to adjust rotation applied to the tool bit, with one of clockwise and counterclockwise being selected.

In some embodiments, the sensor equipped power tool can use sensor information to determine engageable parts geometry and aid selection of a corresponding tool bit.

In some embodiments, the sensor equipped power tool can use an encoder and mapping table to determine a particular tool tip position.

In some embodiments, the sensor equipped power tool can linearly move the movable engagement mechanism.

In some embodiments, the sensor equipped power tool can rotationally move the movable engagement mechanism.

In some embodiments, the sensor equipped power tool can determine material characteristics, detect part characteristics, and set a torque profile based on material and detected part characteristics.

### BRIEF DESCRIPTION OF THE DRAWINGS

Certain aspects of the present technology can be better understood with reference to the following drawings. The relative dimensions in the drawings may be to scale with respect to some embodiments of the present technology. With respect to other embodiments, the drawings may not be to scale. The drawings may also be enlarged arbitrarily. For clarity, reference-number labels for analogous components or features may be omitted when the appropriate reference-number labels for such analogous components or features are clear in the context of the specification and all of the drawings considered together. Furthermore, the same reference numbers may be used to identify analogous components or features in multiple described embodiments.

FIG. 1A is a side cross sectional view of a sensor equipped power tool in a powered on position that is ready to identify a needed tool bit.

FIG. 1B is a top cross sectional view of the sensor equipped power tool of FIG. 1A with a chuck mechanism having chuck jaws in an extended position ready to engage with a tool bit.

FIG. 1C is a zoomed in cross sectional view of the sensor equipped power tool of FIG. 1B illustrating the tool bit holder and tool bits.

FIGS. 1D and 1E are exploded views showing components of the sensor equipped power tool of FIG. 1A.

FIG. 1F is a front cross sectional view of the sensor equipped power tool of FIG. 1A with a chuck mechanism and associated rotational gears.

FIG. 1G is a looking forward front cross sectional view of the sensor equipped power tool of FIG. 1A with a chuck mechanism in an extended position.

FIG. 1H is a looking backward front cross sectional view of the sensor equipped power tool of FIG. 1A with a tool bit holder rotated out of a movement path of the chuck mechanism.

FIG. 1I is a side cross sectional view of the sensor equipped power tool of FIG. 1A illustrating gear rotation of a chuck collar.

FIG. 1J is a zoomed in cross sectional view of the sensor equipped power tool of FIG. 1I illustrating gear rotation of a chuck collar.

FIG. 1K is a side cross sectional view of the sensor equipped power tool of FIG. 1A illustrating extension of chuck jaws to engage a tool bit in the tool bit holder.

FIG. 1L is a zoomed in cross sectional view of the sensor equipped power tool of FIG. 1K illustrating extension of chuck jaws to engage a tool bit in the tool bit holder.

FIG. 1M is a top cross sectional view of the sensor equipped power tool of FIG. 1A illustrating retraction of the chuck back to a home position.

FIG. 1N is a zoomed in cross sectional view of the sensor equipped power tool of FIG. 1M illustrating retraction of the chuck back to a home position.

FIG. 1O is a side cross sectional view of the sensor equipped power tool of FIG. 1A illustrating extension of the chuck and tool bit into a usable position.

FIG. 1P is a zoomed in cross sectional view of the sensor equipped power tool of FIG. 1M illustrating extension of the chuck and tool bit into a usable position.

FIG. 1Q is a top cross sectional view of the sensor equipped power tool of FIG. 1A illustrating components providing an anti-rotational mechanism.

FIG. 1R is a side cross sectional zoomed view of the sensor equipped power tool of FIG. 1A illustrating components providing an anti-rotational mechanism.

FIG. 1S is a line drawing illustrating an anti-rotational mechanism to drive a tool bit.

FIG. 1T is a perspective drawing illustrating an anti-rotational mechanism to drive a tool bit.

FIG. 1U is a top cross sectional view of the sensor equipped power tool illustrating an alternative view of a tool bit ready for use.

FIG. 1V is a side cross sectional view of the sensor equipped power tool illustrating an alternative view of a tool bit moved back into a held position in the tool bit holder.

FIG. 1W is a top cross sectional view of the sensor equipped power tool illustrating an alternative view of a tool bit being moved back into a held position in the tool bit holder.

FIG. 1X is a front cross sectional view of the sensor equipped power tool illustrating an alternative view of a tool bit being moved back into a held position in the tool bit holder.

FIG. 1Y is a top cross sectional view of the sensor equipped power tool illustrating an alternative view of a home position.

FIG. 1Z is a side cross sectional view of the sensor equipped power tool illustrating an alternative view of a home position.

FIG. 2A is a perspective view of an alternative sensor equipped power tool having a single actuator or motor that serves a dual purpose of extending a chuck and tool bit and powering the driver and tool bit.

FIG. 2B is a side view of an alternative sensor equipped power tool having a centrally mounted camera and a single actuator or motor that serves a dual purpose of extending a chuck and tool bit and powering the driver and tool bit.

FIG. 3A is a side view of an alternative sensor equipped power tool having a housing that defines a pistol grip and having an engagement mechanism that can be rotated and is in a first position.

FIG. 3B is a side view of an alternative sensor equipped power tool having a housing that defines a pistol grip and having an engagement mechanism that is being rotated toward a second position.

FIG. 3C is a side view of an alternative sensor equipped power tool having a housing that defines a pistol grip and having an engagement mechanism that has been rotated into a second position.

FIG. 3D is a perspective view of an alternative sensor equipped power tool having an engagement mechanism that is in a first position and ready to engage with a tool bit.

FIG. 4A is a side view of an alternative sensor equipped power tool having an engagement mechanism that can be rotated and is in a first position.

FIG. 4B is a side view of an alternative sensor equipped power tool having an engagement mechanism that has been rotated into a second position.

FIG. 5 is a perspective view of an alternative sensor equipped power tool having a crank slider mechanism to extend or retract a chuck mechanism.

FIG. 6A illustrates one embodiment of a method of operation of the sensor equipped power tool described in this disclosure.

FIG. 6B illustrates a method for automatically setting drilling/driving direction as clockwise or counterclockwise

FIG. 6C illustrates a detailed method for detecting parts and providing a needed tool bit.

FIG. 6D illustrates a method for determining drilling mode or screw-driving mode.

FIG. 6E illustrates a method for using computer vision to determine diameter of the bolt, length of bolt, length of nut, or thread information to automatically drive a part at an ideal torque using a correct RPM profile.

FIG. 6F illustrates a method for synchronization with a mobile app and using building or assembly instructions.

FIG. 6G illustrates a method for remote software updates for the sensor equipped power tool and an ability to optimize performance using user submitted feedback.

### DETAILED DESCRIPTION

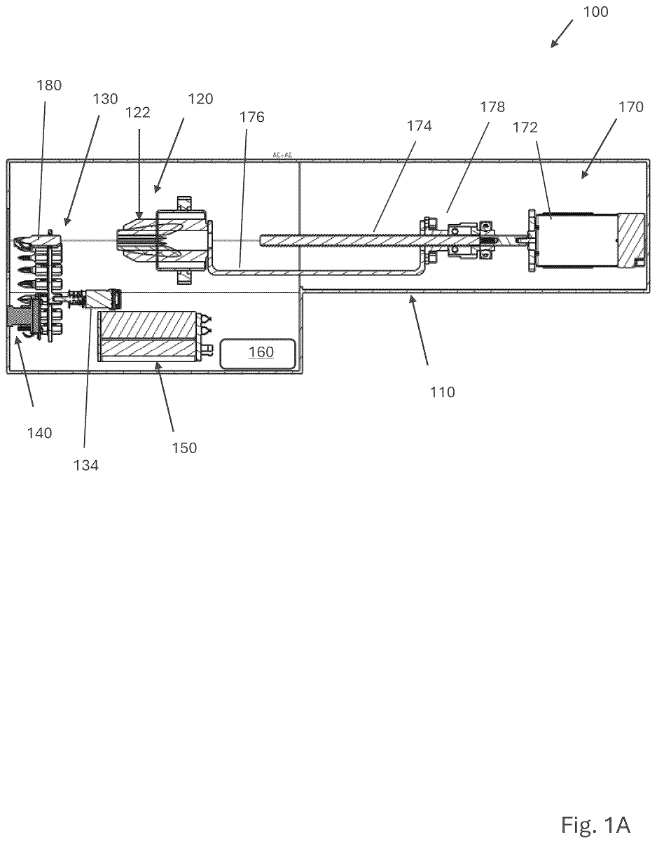

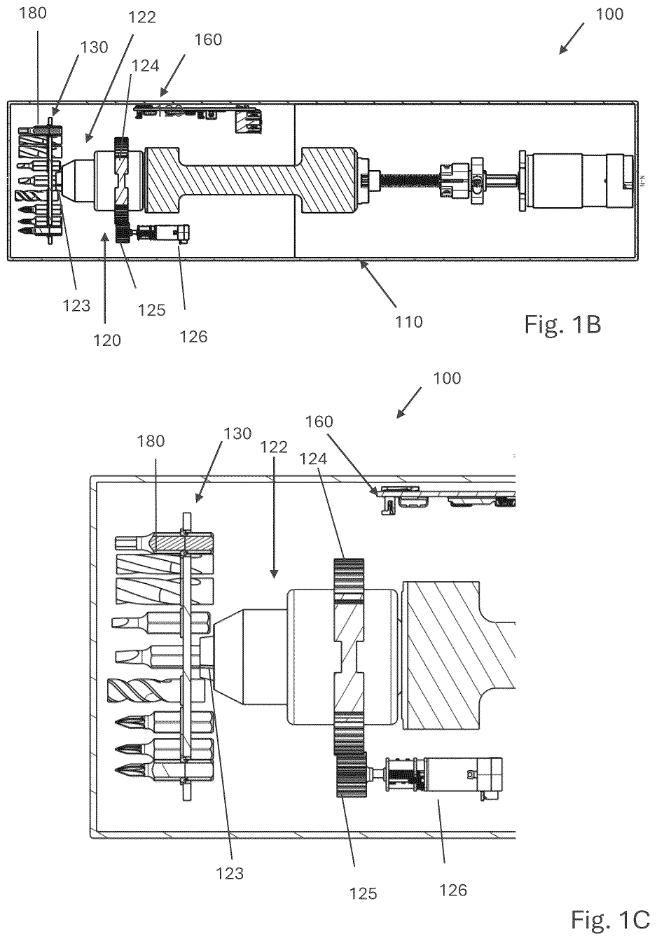

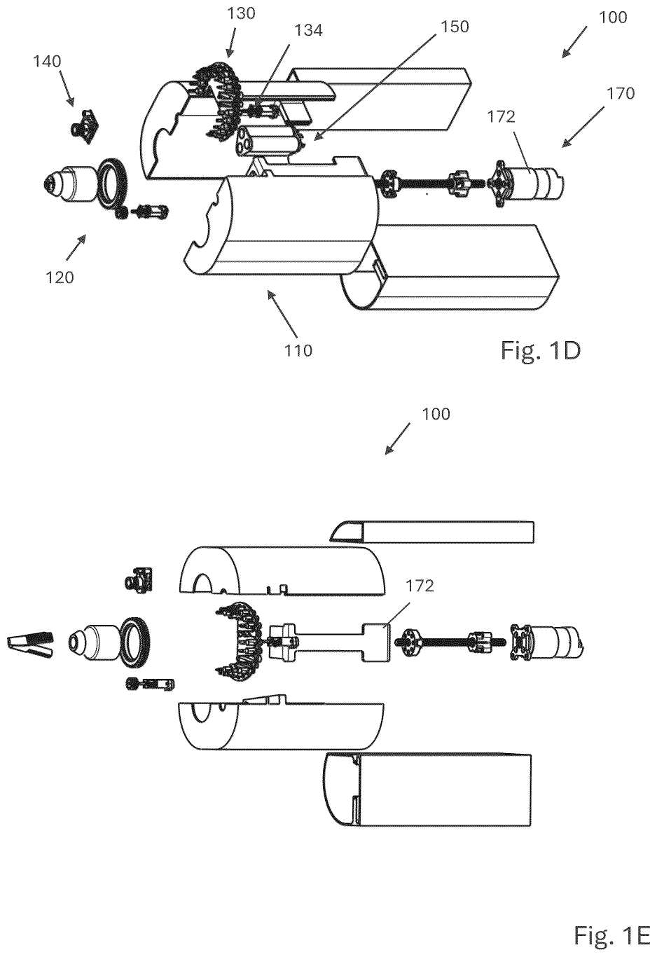

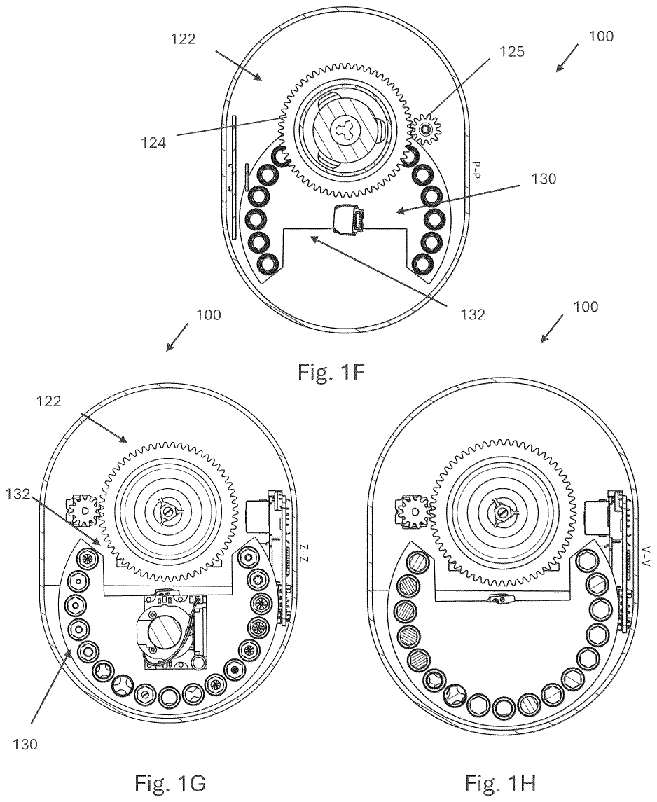

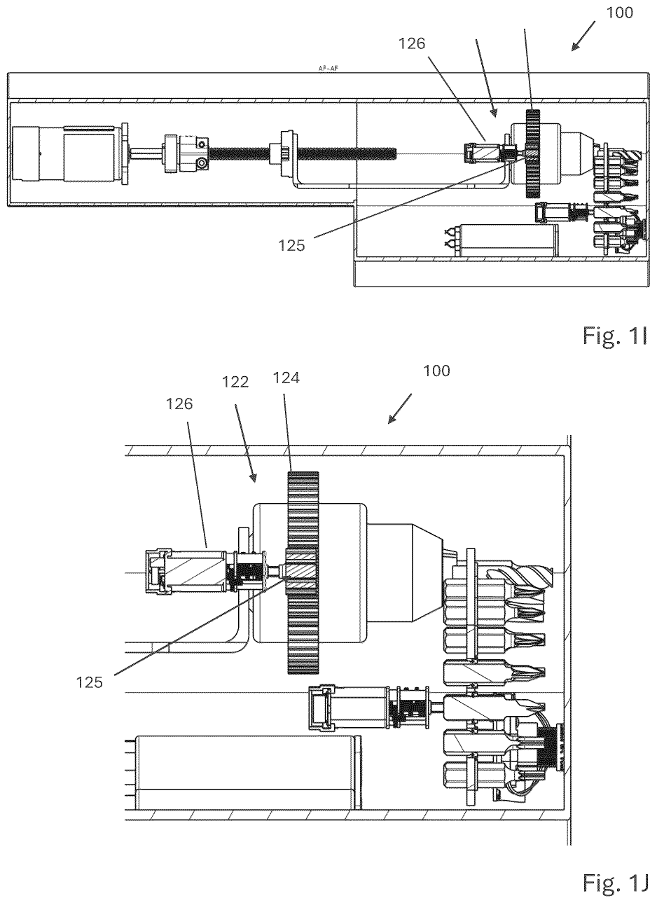

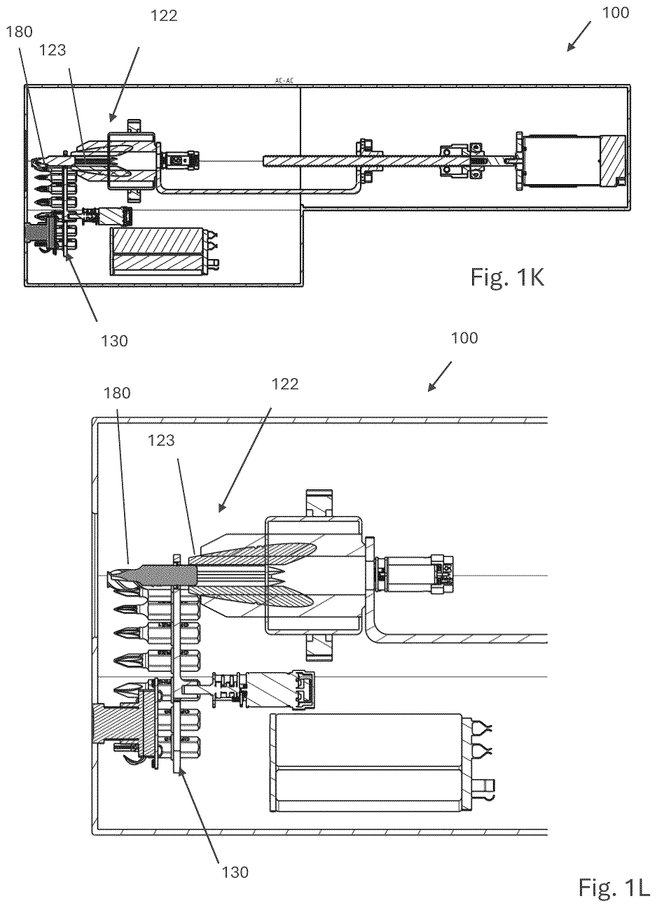

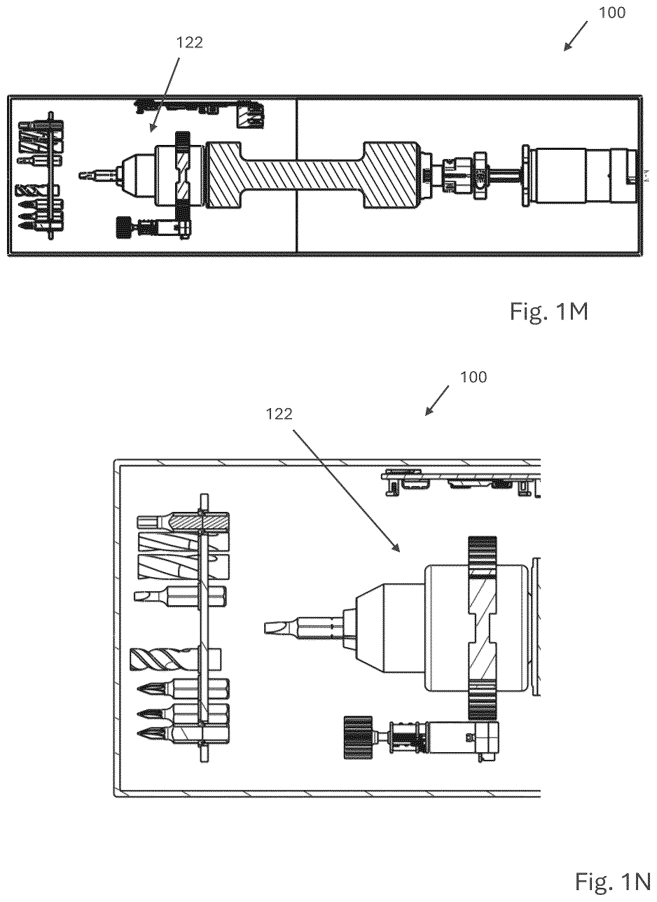

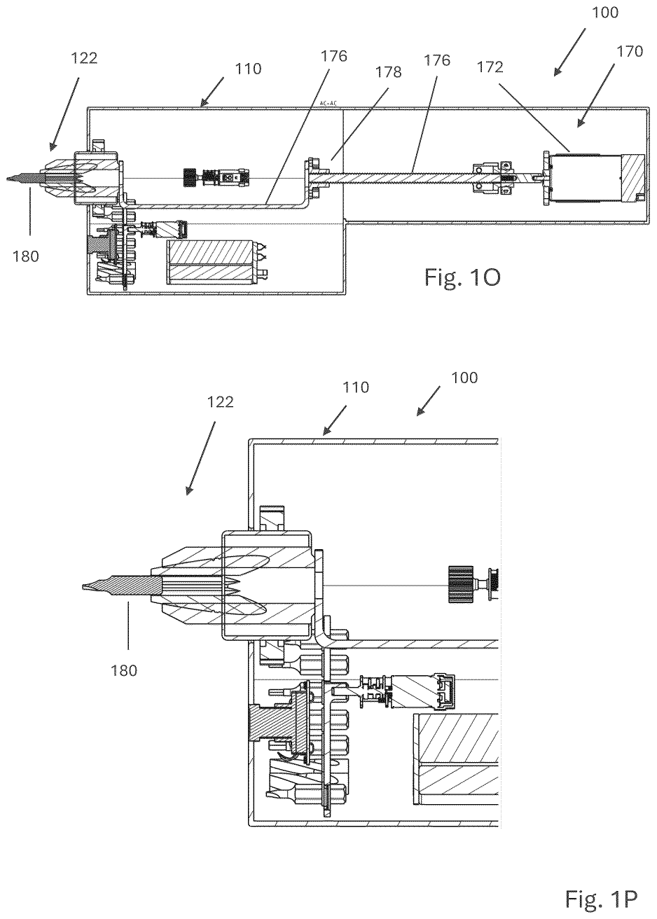

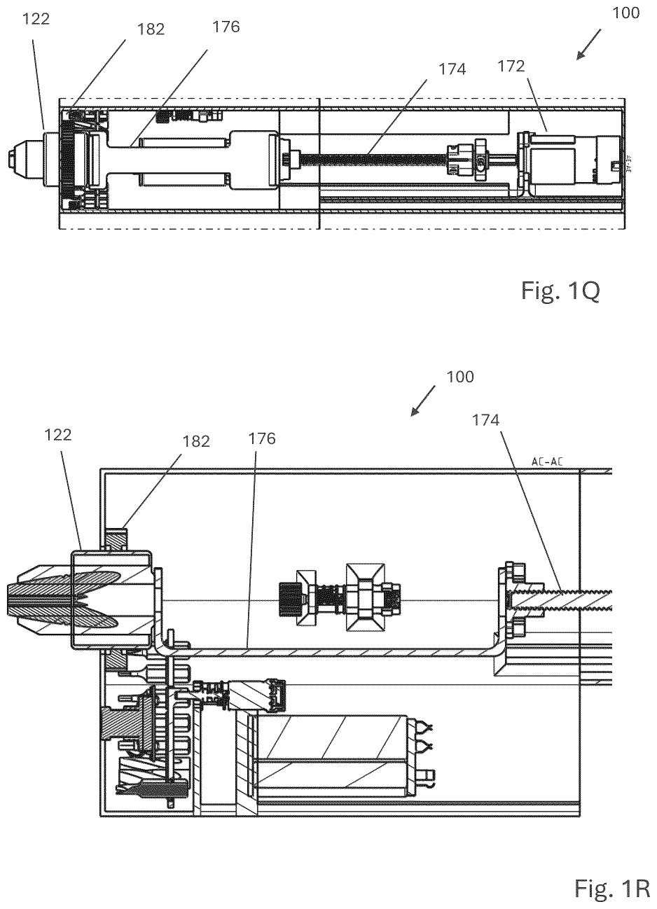

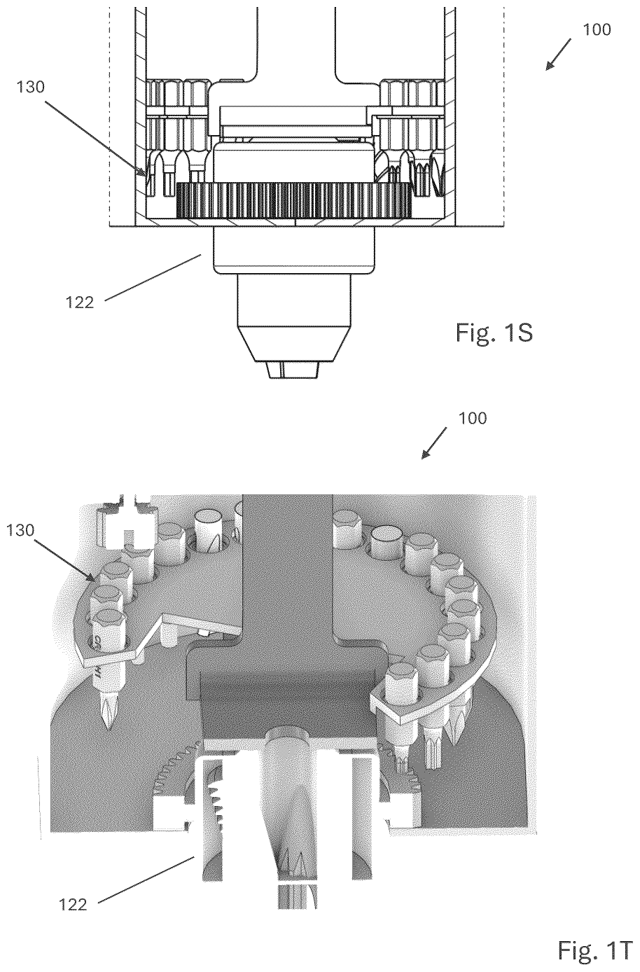

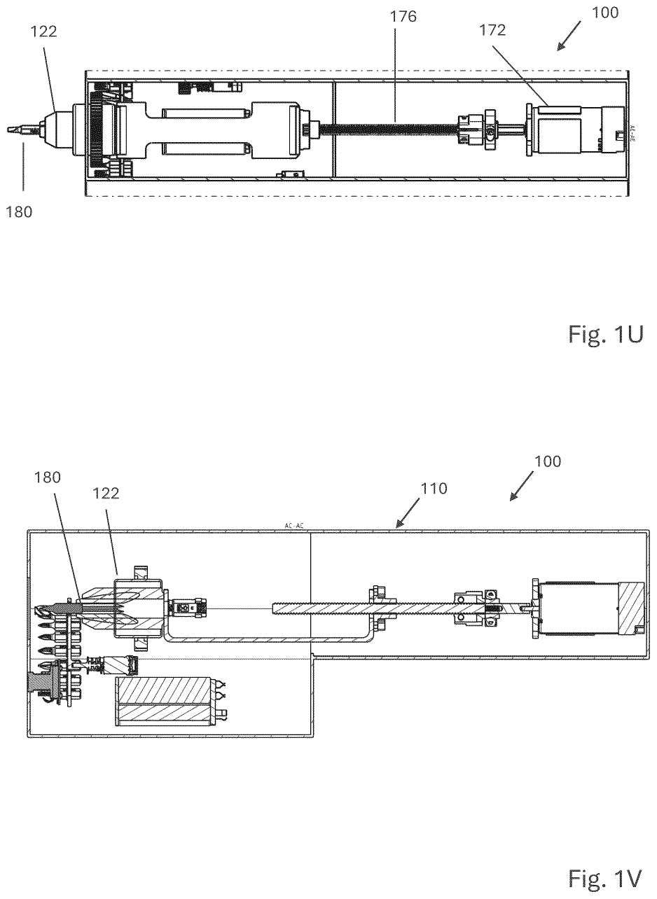

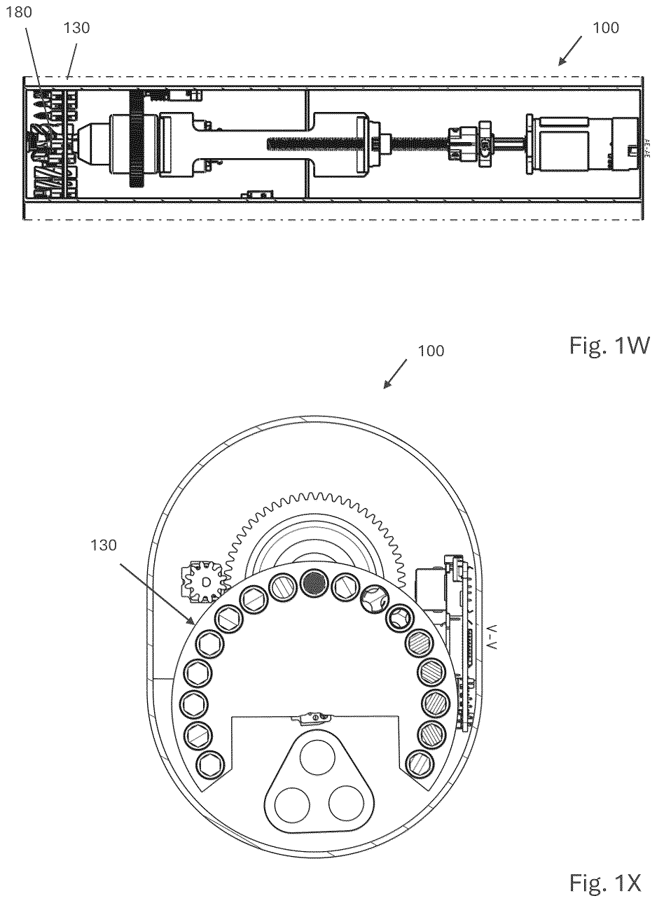

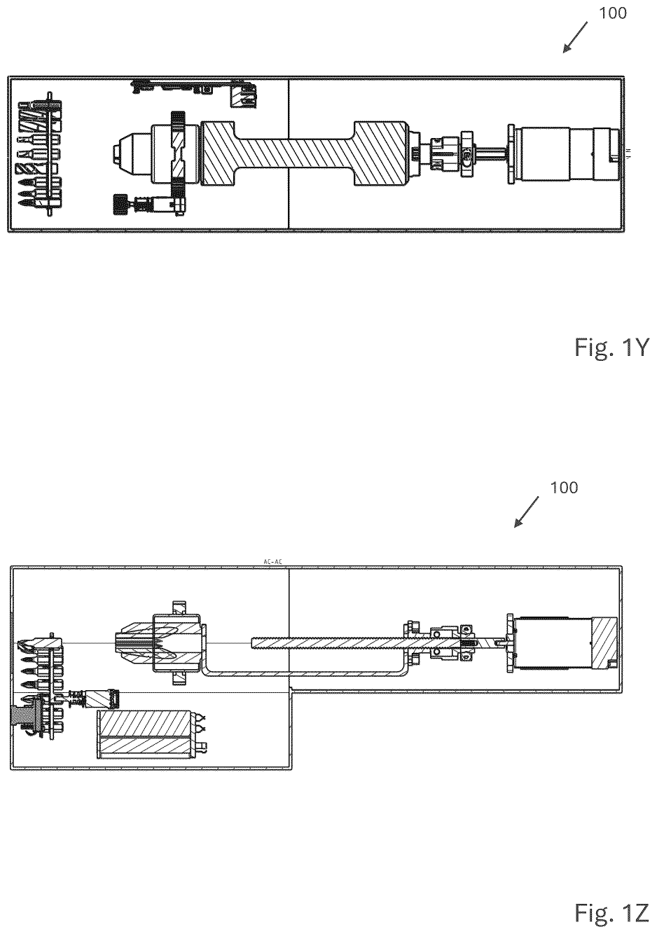

FIG. 1A is a side cross sectional view of a sensor equipped power tool 100 having housing 110 that supports a movable engagement mechanism 120 and a tool bit holder 130 for tool bits 180. A sensor 140 can be attached to the housing in a manner that allows inspection of the environment. A power system 150 provides power for movement of engagement mechanism 120, and a control system 160 is connected to control operation of the sensor equipped power tool 100. In some embodiments, the control system 160 operates to identify any potentially engageable parts such as screws, nuts, bolts, fasteners, connectors, rivets, pins, clips or the like. The sensor equipped power tool 100 also includes a power drive mechanism 170 that include a motor 172, lead screw 174, and carriage 176 that is attached to both the movable engagement mechanism 120 and coupling 178 supported by lead screw 174.

In some embodiments the housing 110 can partially or wholly surround the movable engagement mechanism 120 and tool bit holder 130, as well as the power system 150 and control system 160. The housing 110 can be constructed of metal, plastics, composites, or other materials. In some embodiments the housing 110 can be configured to have a pistol grip. In other embodiments, the housing can include gripping ridges or depressions to improve manual grasping characteristics.

In some embodiments the movable engagement mechanism 120 can be linearly, rotationally, or both linearly and rotationally, movable between tool bit engaged and non-engaged positions. Further, the movable engagement mechanism 120 can include a holder or chuck mechanism 122 operable to grab, hold, and release tool bits 180. The chuck mechanism 122 can include but is not limited to a mechanical, electromagnetic, or pneumatic chucks.

In some embodiments the tool bit holder 130 can be fixed or movable with respect to the housing 110. A wide variety of mechanisms can be used to allow capture or formation of a needed tool bit 180. For example, a cam mechanism or any other suitable mechanism can be used for moving tool bits 180 held in the tool bit holder 130 into position for engagement with the engagement mechanism 120. In some embodiments, a sector gear or sector/semicircle/arc/circle with bits housed in it can be used. In some embodiments, a desired tool bit 180 geometry can be created or enabled by reconfiguring components that can be assembled into a desired tool bit configuration. For example different sheets/building blocks/triangles defining a tessellated or other movable structure can be combined in a manner that emulates a solid and unitary tool bit 180. In some embodiments, tool bits 180 can be positioned outside the housing 110 and external to the sensor equipped power tool 100. For example, tool bits 180 can be in an externally positioned tool bit holder or box, and a robotic manipulator or hand can grab the needed tool bit.

In some embodiments, tool bit 180 identification and any needed repositioning of the engagement mechanism 120 or holder 130 is automatically provided by the control system 160. In other embodiments tool bit 180 identification and any needed repositioning of the engagement mechanism 120 or tool bit holder 130 is provided by the control system 160 in response to data received from sensor 140. In still other embodiments, tool bit 180 identification and any needed repositioning of the engagement mechanism 120 or tool bit holder 130 can automatically be provided by external automated sources. In some embodiments an actuator 134 is connected to the tool bit holder 130 and provides rotational or other movement to reposition tool bits held by the tool bit holder 130.

In some embodiments, a user can provide some or all of any needed tool bit 180 identification and repositioning of the engagement mechanism 120 or tool bit holder 130. For example, a user can select the tool bit 180 via a phone app and have the engagement mechanism 120 or tool bit holder 130 operate to allow engagement by the engagement mechanism 120 with the tool bit 180. In other embodiments, a user can select a tool bit 180 via a touch screen attached or associated with the sensor equipped power tool 100. In some embodiments, a user can use a camera from a phone or other connected device to sense and identify tool bit 180 geometry or size. In some embodiments, a user can manually position the tool bit 180 by grasping the tool bit 180 and moving it into position for engagements with engagement mechanism 120. In other embodiments, a user can lift, slide, or rotate the housing and/or tool bit holder 130 to allow access to a needed tool bit.

A wide variety of tool bits can be used in conjunction with the tool bit holder 130. For example tool bits can be screwdriver bits such as slotted/flathead, Phillips, Pozidriv, Torx, Hex/Allen, or Robertson screwdriver bits. Other tool bits can include drill bits such as twist drill Bits, spade bits, auger bits, masonry bits, Forstner bits, or step drill bits. Other example tool bits can include deburring tools, threading and tapping tools, rotary grinding tools, rotary sanding tools, or external hex head bolt drivers.

In some embodiments the sensor 140 can include one or more camera sensors for capturing image data related to parts, construction materials, or the environment. In various embodiments, sensor 140 may be affixed to the housing 110 of the sensor equipped power tool 100, attached at different locations, and oriented in one or more different directions. For example, sensor(s) 140 may be affixed to the front, sides, rear, or bottom of the housing 110 in forward-facing, rear-facing, side-facing, or other directions. In some embodiments, the sensor 140 may be image sensors such as high dynamic range cameras and/or cameras with different fields of view. In some embodiments, a sensor 140 can include a wide forward camera, a narrow forward camera, a rear view camera, forward looking side cameras, and/or rearward looking side cameras.

In some embodiments, sensor 140 can include active emitters such as radar, ultrasonic, and/or lidar sensors. In some embodiments, the sensor 140 include non-visual sensors. Additional sensors 140 may include audio, electromagnetic, inertia, odometry, location, or global positioning system (GPS) sensors, encoders, current sensors, load cells, torque transducers, ultrasonic sensors, proximity sensors, accelerometers, Hall effect sensors, or gyroscopes.

In some embodiments, sensor 140 can include multiple sensors, with some attached to the housing 110 and others removable or unattached with respect to the housing 110. In some embodiments, the sensor equipped power tool 100 can use other sensors such as are available through wireless connection to a smartphone, tablet, or other fixed or mobile computing device.

In some embodiments the power system 150 can include corded attachment(s) to electrical power providers, or can house rechargeable or replaceable batteries. In some embodiments, pneumatic systems can be used to additionally provide rotary or drive power. The power system 150 can include a battery and a charger. The battery can be a lithium-ion battery, a lead-acid battery, or another suitable type of battery. The charger can include a connector (not shown) compatible with a power source (e.g., a wall outlet) and leads (also not shown) extending between the connector and the battery.

In some embodiments the control system 160 can control activation, deactivation, and usage of the linearly movable engagement mechanism 120, and the sensor 140. When suitable, operations described elsewhere in this disclosure (e.g., actions or movements of various described components) can be implemented this electrical and computer system components autonomously and/or in response to instructions from a user. Electrical and computer systems utilized by the control system 160 may also be used to process measurements generated by sensor 140. The computing components of the control system 160 can include a processor, such as one or more general-purpose and/or special-purpose integrated circuits including digital logic gates for executing programs and/or for otherwise processing data. The control system 160 can further include memory, such as one or more integrated circuits for storing data in use. The memory can include a multithreaded program, an operating system including a kernel, device drivers, etc. The control system 160 can further include persistent storage, such as a flash-memory drive for persistently storing data. Examples of data that can be stored by the persistent storage include diagnostic data, sensor data, configuration data, environmental data, and current-state data. The control system 160 can collectively define a computer configured to manage, control, receive information from, deliver information to, and/or otherwise usefully interact with other components of the control system 160.

The control system 160 can further include communication components. The communication components can include a computer-readable media drive for reading computer programs and/or other data stored on computer-readable media. As one example, the computer-readable media drive can be a flash-memory drive. The communication components can further include a network connection to other devices and systems, such as other sensor equipped power tools 100, smart phones, and/or other computer systems. The network connection can be wired and/or wireless and can be via the Internet, a Local Area Network (LAN), a Wide Area Network (WAN), Bluetooth, WiFi, or a cell phone network. The network connection can include networking hardware, such as routers, switches, transmitters, receivers, computer-readable transmission media, etc. The communication components can further include the display and/or other suitable components for communicating with a user. The control system 160 can use the communication components for internal operations and/or to interact with devices and/or systems external to the control system 160, such as systems for providing contextual information about the environment in which the control system 160 operates and/or systems for changing operating conditions of the control system 160.

As noted, in some embodiments the parts can include but are not limited to screws, nuts, bolts, fasteners, connectors, rivets, pins, clips or the like. Other parts can include studs, anchors, nails, brads, trim nails, or finishing nails. A wide variety of screws including flat head, machine screws, masonry, hex leg, or sheet screws can be used.

FIG. 1B is a top cross sectional view of the sensor equipped power tool 100 of FIG. 1A with the movable engagement mechanism 120 including chuck mechanism 122 having chuck jaws 123 in an extended position ready to engage with a tool bit 180 held in a tool bit holder 130. As illustrated, the chuck mechanism 122 has chuck collar 124 that can be rotated by a gear 125 attached to chuck collar actuator 126, to open or close the chuck jaws of the chuck mechanism 122.

FIG. 1C is a zoomed in cross sectional view of the sensor equipped power tool 100 of FIG. 1B to better illustrate position and details of the tool bit holder 130 and diverse range of held tool bits. Also illustrated is positioning of the chuck collar 124 and gear 125 attached to chuck collar actuator 126.

FIGS. 1D and 1E are exploded views showing components of the sensor equipped power tool 100 of FIG. 1A. Illustrated are housing 110 that supports the movable engagement mechanism 120 and the tool bit holder 130 for tool bits. The sensor 140, power system 150, control system 160, and power drive mechanism 170 that includes the motor 172 are also shown.

FIG. 1F is a front cross sectional view of the sensor equipped power tool 100 of FIG. 1A with a chuck mechanism 122 and associated rotational gears 125, as well as the tool bit holder 130. The tool bit holder is generally circular, with a removed section 132 that can be rotated into a position to allow extension partially therethrough of the chuck mechanism 122. As illustrated, the chuck mechanism 122 has chuck collar 124 that can be rotated by gear 125 attached to chuck collar actuator 126 to open or close the chuck jaws of the chuck mechanism 122.

FIG. 1G is a looking forward cross sectional view of the sensor equipped power tool 100 of FIG. 1A with the removed section 132 of the tool bit holder 132 being rotated into a position to allow extension partially therethrough of the chuck mechanism 122.

FIG. 1H is a looking backward cross sectional view of the sensor equipped power tool 100 of FIG. 1A with the removed section 132 of the tool bit holder 132 being rotated into a position to allow extension partially therethrough of the chuck mechanism 122.

FIG. 1I is a side cross sectional view of the sensor equipped power tool of FIG. 1A illustrating gear rotation of a chuck collar. Illustrated are the chuck mechanism 122 with chuck collar 124 that can be rotated by gear 125 attached to chuck collar actuator 126.

FIG. 1J is a zoomed in cross sectional view of the sensor equipped power tool 100 of FIG. 1I illustrating position and details of the chuck mechanism 122, chuck collar 124, and gear 125 attached to chuck collar actuator 126.

FIG. 1K is a side cross sectional view of the sensor equipped power tool 100 of FIG. 1A illustrating the chuck mechanism 122 and extension of chuck jaws 123 to engage a tool bit 180 in the tool bit holder 130.

FIG. 1L is a zoomed cross sectional view of the sensor equipped power tool 100 of FIG. 1A illustrating the chuck mechanism 122 and extension of chuck jaws 123 to engage a tool bit 180 in the tool bit holder 130.

FIG. 1M is a top cross sectional view of the sensor equipped power tool 100 of FIG. 1A illustrating retraction of the chuck back to a home position.

FIG. 1N is a zoomed in cross sectional view of the sensor equipped power tool 100 of FIG. 1M illustrating retraction of the chuck 122 back to a home position.

FIG. 1O is a side cross sectional view of the sensor equipped power tool 100 of FIG. 1A illustrating extension of the chuck mechanism 122 and tool bit 180 into a usable position outside the housing 110. In the position is also illustrated power drive mechanism 170 that include motor 172, lead screw 174, and carriage 176 that is attached to the chuck mechanism 122 and linearly drivable by motor 172.

FIG. 1P is a zoomed in cross sectional view of the sensor equipped power tool 100 of FIG. 1M illustrating extension of the chuck mechanism 122 and tool bit 180 into a usable position outside the housing 110.

FIG. 1Q is a top cross sectional view of the sensor equipped power tool 100 of FIG. 1A illustrating components providing an anti-rotational mechanism. In this embodiment, motor 172 is both used to extend/retract the chuck mechanism 122 and provide drive torque using selective anti-rotational features. The chuck mechanism 122 and potentially engaged tool bit (not shown) are positioned to be concentric/coaxial with respect to the lead screw 174 and motor 172. Other than the fully extended position, the carriage 176 carrying the chuck mechanism 122 is constrained with anti-rotation key-slots 182 to housing trim. This makes the chuck mechanism 122 and driven tool bit by the lead screw 174 linearly translate without rotating. The design selectively does not have anti-rotation constraints at the completely deployed position.

FIG. 1R is a side cross sectional zoomed view of the sensor equipped power tool 100 of FIG. 1Q illustrating components providing an anti-rotational mechanism. To drive the bit clockwise, the lead screw 174 and carriage 176 can turn clockwise. It is not anti-rotationally constrained so the chuck mechanism 122 will rotate, providing torque to the sensor equipped power tool 100. The chuck mechanism 122 will not move forward as the chuck bottoms out on the housing trim and is constrained on the face it is moving forward. Lead screw 174 enacts a forward translation with clockwise rotation if un-constrained. In effect, this will result in purely rotational motion for a tool bit (not shown), given only translation constraints present at this position.

FIG. 1S is a line drawing illustrating aspects of a sensor equipped power tool 100 supporting an anti-rotational mechanism to drive a tool bit (not shown). In this embodiment, to drive the tool bit (not shown) counterclockwise the motor (not shown) will turn counter clockwise. It is not anti-rotationally constrained so the chuck mechanism 122 will rotate, providing torque to the tool bit. The chuck mechanism 122 will not move rearward into the sensor equipped power tool 100 as the chuck mechanism 122 bottoms out on a tool bit holder 130 that holds all the tool bits and so is constrained on the face as it is moving rearward. The lead screw 174 (not shown) enacts a rearward translation plus counterclockwise rotation if un-constrained, and this results in purely rotational motion on the tool bit, given only translation constraints.

FIG. 1T is a perspective drawing illustrating an anti-rotational mechanism to drive a tool bit counterclockwise. In this embodiment the motor 172 (not shown) will turn counter clockwise. Since it is not anti-rotationally constrained the chuck mechanism 122 will rotate, providing torque to the tool bit. The chuck mechanism 122 will not move rearward into the sensor equipped power tool 100 as the chuck mechanism 122 bottoms out on a tool bit holder 130 that holds all the bits/tools and so is constrained on the face as it is moving rearward. The lead screw 174 (not shown) enacts a rearward translation plus counterclockwise rotation if un-constrained and this results in purely rotational motion on a tool bit, given only translation constraints.

FIG. 1U is a top cross sectional view of the sensor equipped power tool 100 illustrating an alternative view of a tool bit 180 ready for use. Illustrated is a mechanism to drive the tool bit 180 clockwise, with the motor 172 turning clockwise. It is not anti-rotationally constrained so the chuck mechanism 122 will rotate, providing torque to the tool bit 180. The chuck mechanism 122 will not move forward as the chuck bottoms out on housing trim and so is constrained on the face it is moving forward. Lead screw 174 enacts a forward translation plus clockwise rotation if un-constrained. This results in purely rotational motion on a tool bit, given only translation constraints are present at this position.

To better understand aspects of motor rotation, lead screw motion, constraints, and chuck mechanism effect and position for the described sensor equipped power tool 100, the following Table 1 is presented:

| Motor | Lead Screw | | | Chuck |
|---|---|---|---|---|
| Rotation | Motion | Constraints | Result | Position |
| Counter | Counter | Rotation | Extend | Within Tool |
| Clockwise | Clockwise + | | Chuck | |
| | Forward | | | |
| Clockwise | Clockwise + | Rotation | Retract | Within Tool |
| | Rearward | | Chuck | |
| Clockwise | Clockwise + | Rearward | CW Power | Deployed, |
| | Rearward | | Chuck | Usable Tool |
| Counter | Counter | Forward | CCW | Deployed, |
| Clockwise | Clockwise + | | Power | Usable Tool |
| | Forward | | Chuck | |

In effect, Table 1 shows how the sensor equipped power tool 100 can use one motor to linearly translate by using anti-rotation constraints, as well as rotate to torque the tool by using linear constraints.

FIG. 1V is a side cross sectional view of the sensor equipped power tool 100 illustrating an alternative view of a tool bit 180 moved back into a held position in the tool bit holder 130.

FIG. 1W is a top cross sectional view of the sensor equipped power tool 100 illustrating an alternative view of a tool bit 180 being moved back into a held position in the tool bit holder 130.

FIG. 1X is a front cross sectional view of the sensor equipped power tool 100 illustrating an alternative view of a tool bit (not shown) moved back into a held position in behind the tool bit holder 130.

FIG. 1Y is a top cross sectional view of the sensor equipped power tool 100 illustrating an alternative view of a home position.

FIG. 1Z is a side cross sectional view of the sensor equipped power tool 100 illustrating an alternative view of a home position.

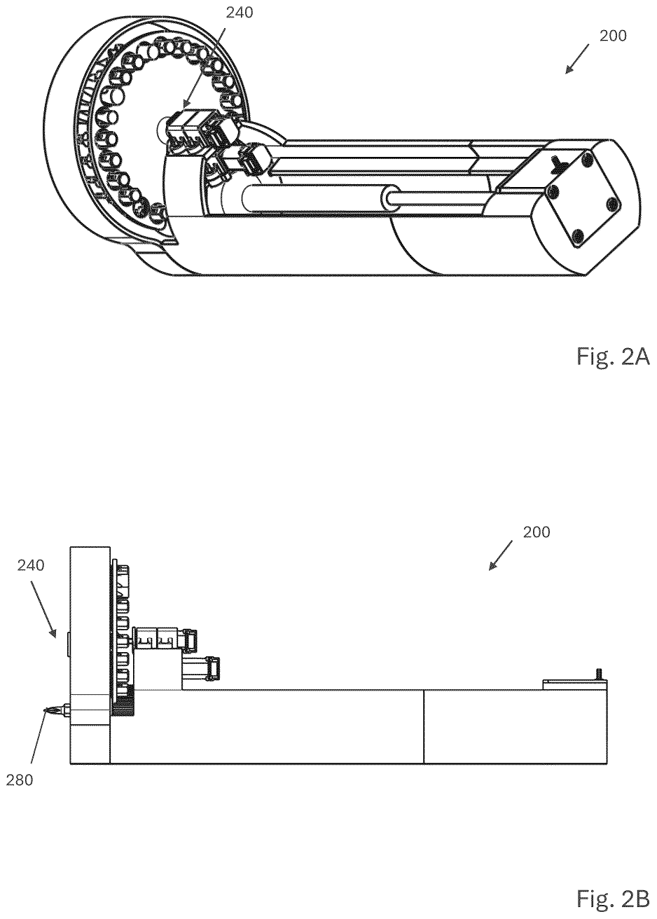

FIG. 2A is a perspective view of an alternative sensor equipped power tool 240 having a single motor that serves a dual purpose of extending a chuck and tool bit (not shown) and powering the driver and tool bit.

FIG. 2B is a side view of an alternative sensor equipped power tool 200 having a centrally mounted camera 240 and a single motor that serves a dual purpose of extending a chuck and tool bit 280 and powering the driver and tool bit 280.

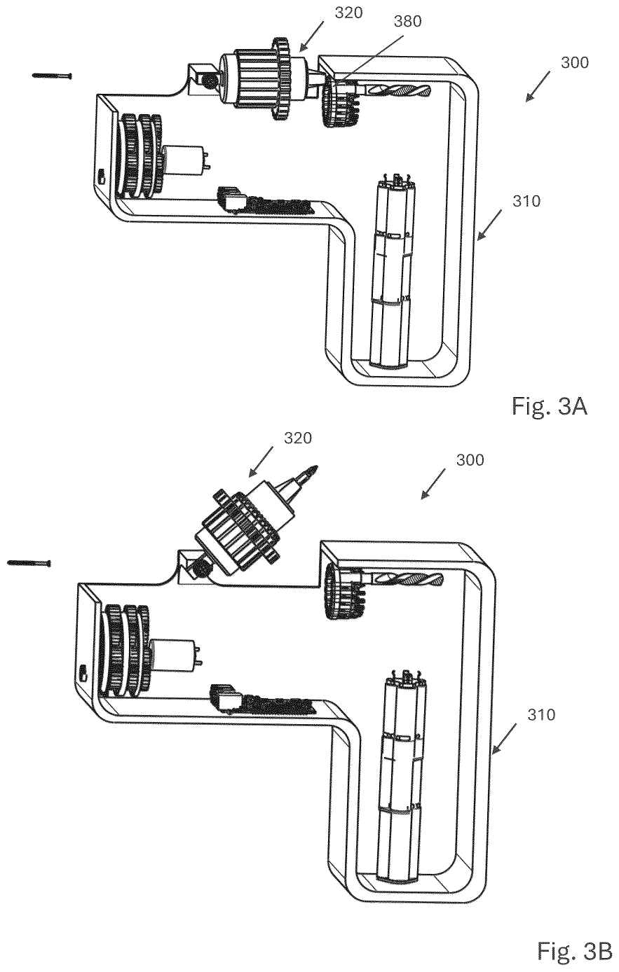

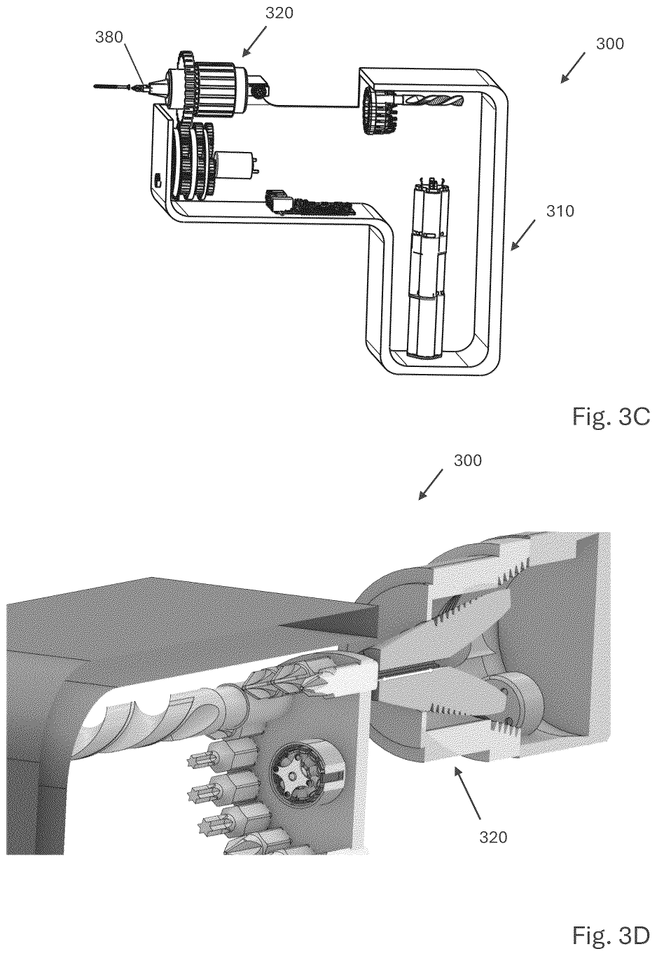

FIG. 3A is a side view of an alternative sensor equipped power tool 300 having a housing that defines a pistol grip 310 and having an engagement mechanism 320 that can be rotated and is in a first position ready to release or grab and hold a tool bit 380.

FIG. 3B is a side view of an alternative sensor equipped power tool 300 having a housing that defines pistol grip 310 and having engagement mechanism 320 that is being rotated toward a second position.

FIG. 3C is a side view of an alternative sensor equipped power tool having a housing that defines pistol grip 310 and having an engagement mechanism 320 that has been rotated into a second position to permit use of the tool bit 380.

FIG. 3D is a detailed perspective view of an alternative sensor equipped power tool 300 having an engagement mechanism 320 that is in a first position and ready to either engage or disengage with a tool bit.

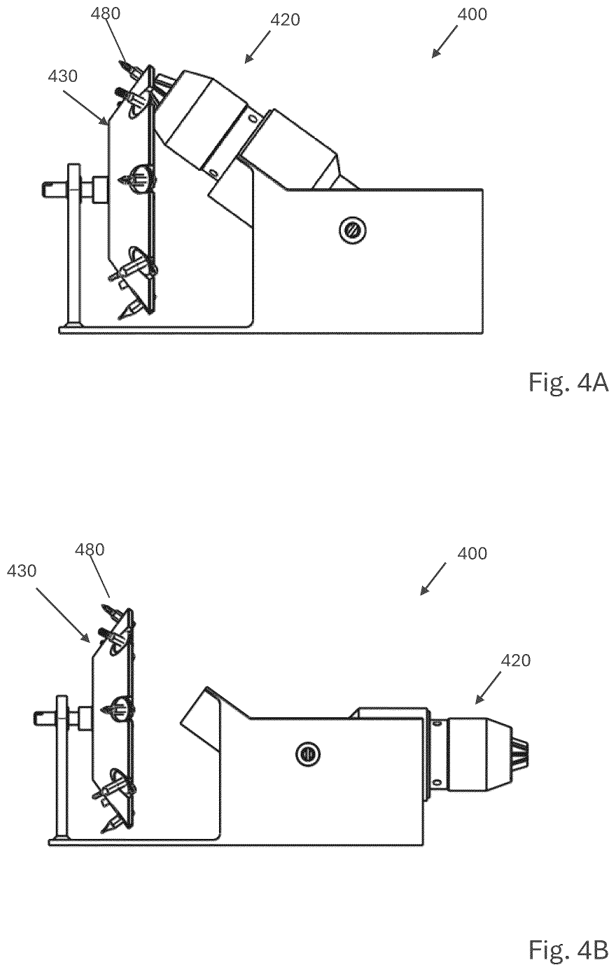

FIG. 4A is a side view of an alternative sensor equipped power tool 400 having an engagement mechanism 420 that can be rotated and is in a first position ready to either engage or disengage with a tool bit 480 held in a tool bit holder 430.

FIG. 4B is a side view of an alternative sensor equipped power tool 400 having an engagement mechanism 420 that has been rotated away from the tool bit holder 430 into a second position without the tool bit 480.

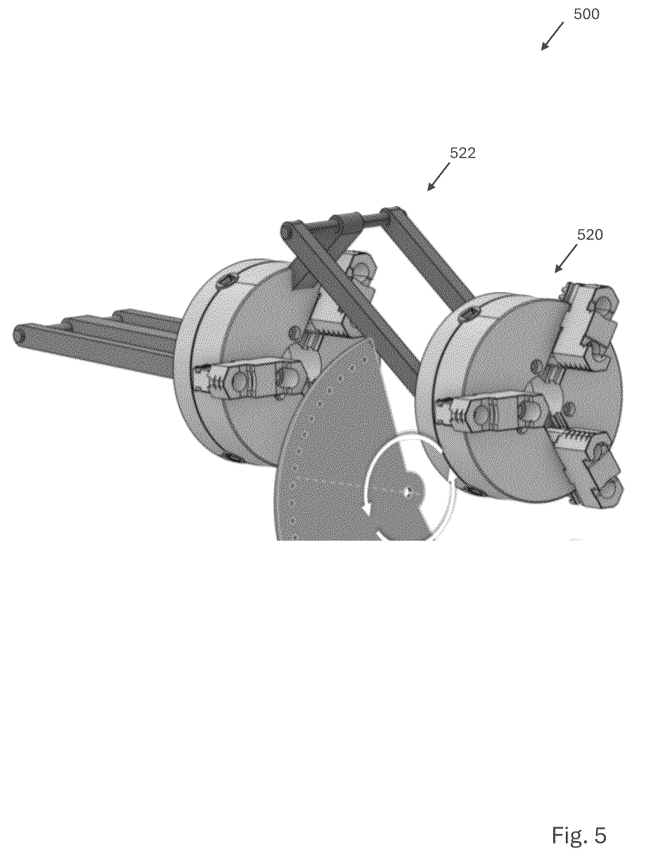

FIG. 5 is a perspective view of an alternative sensor equipped power tool 500 having a crank slider mechanism 522 to extend or retract a chuck mechanism 520.

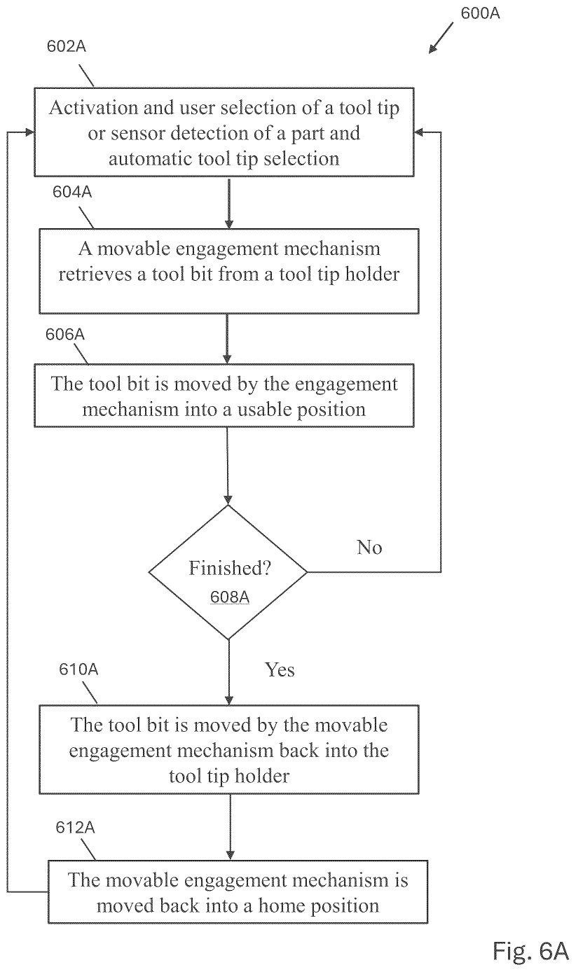

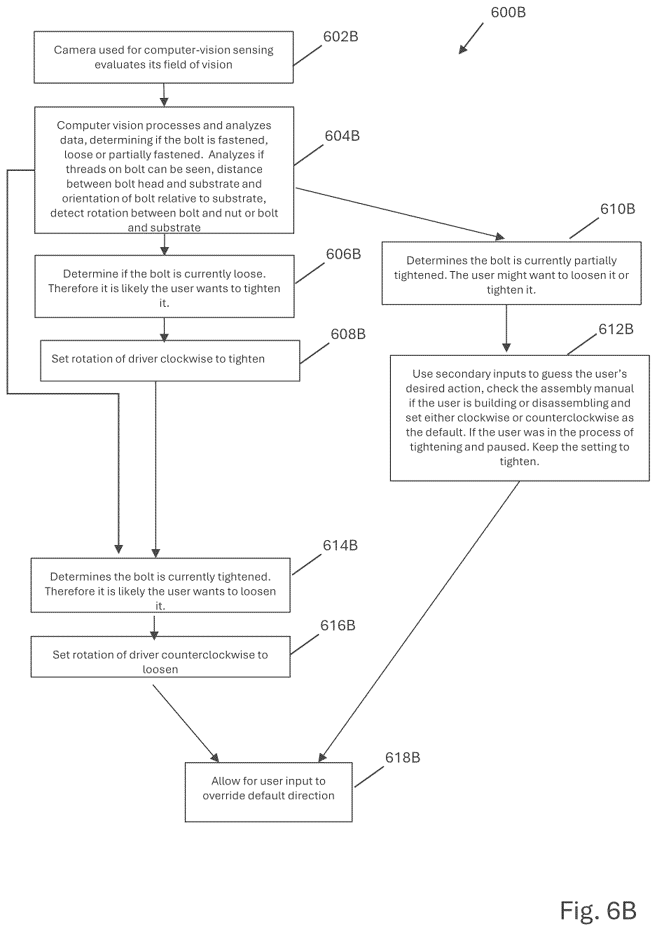

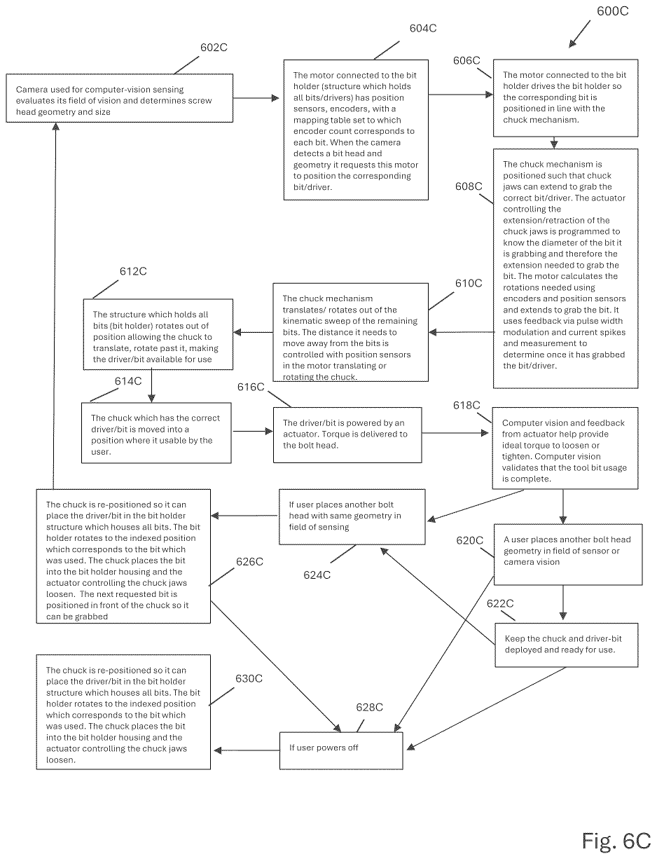

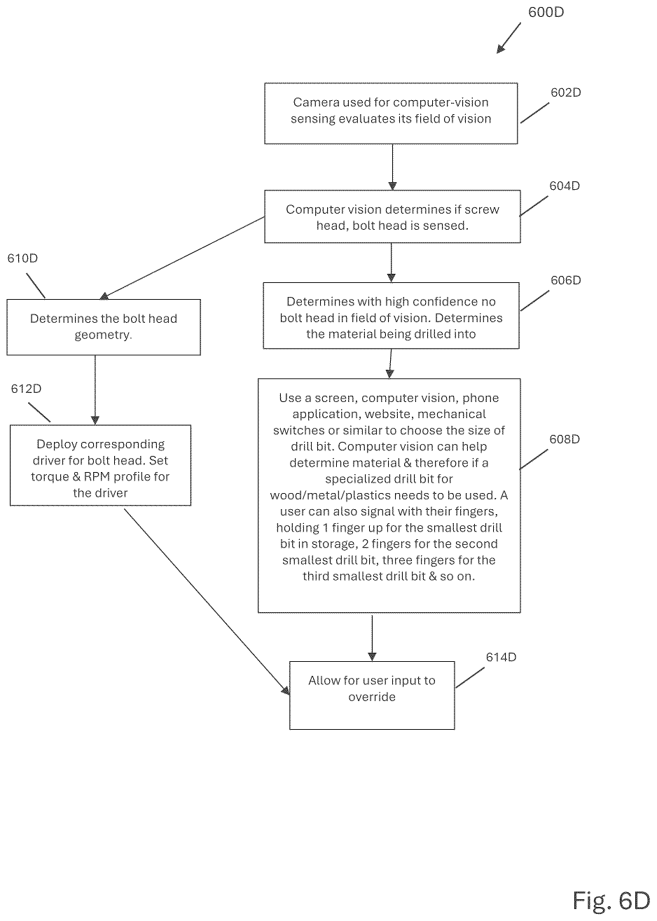

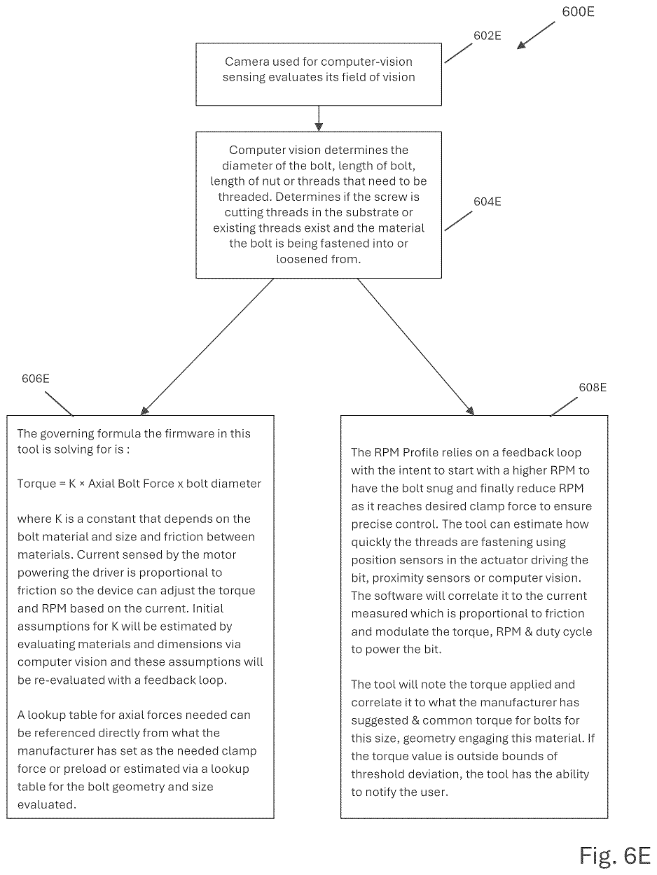

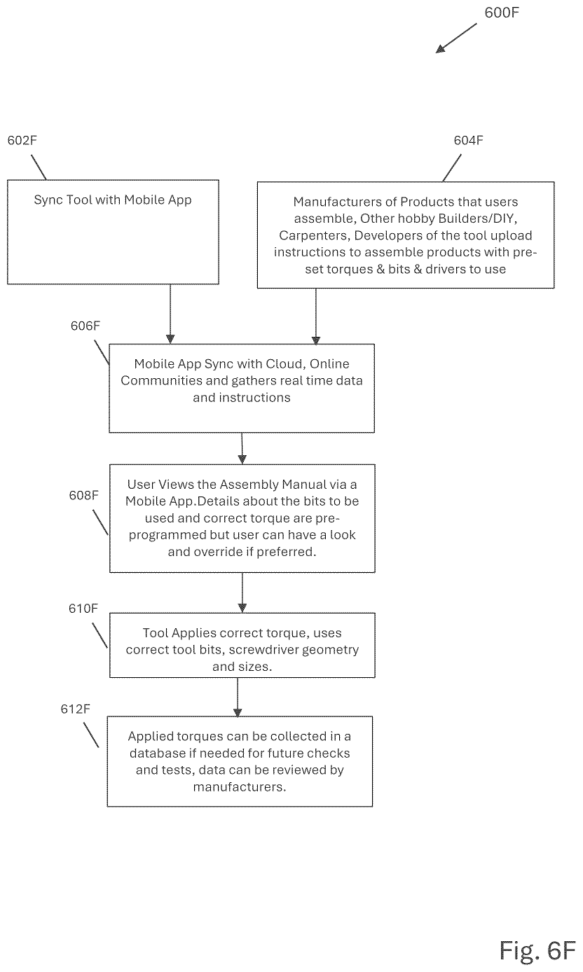

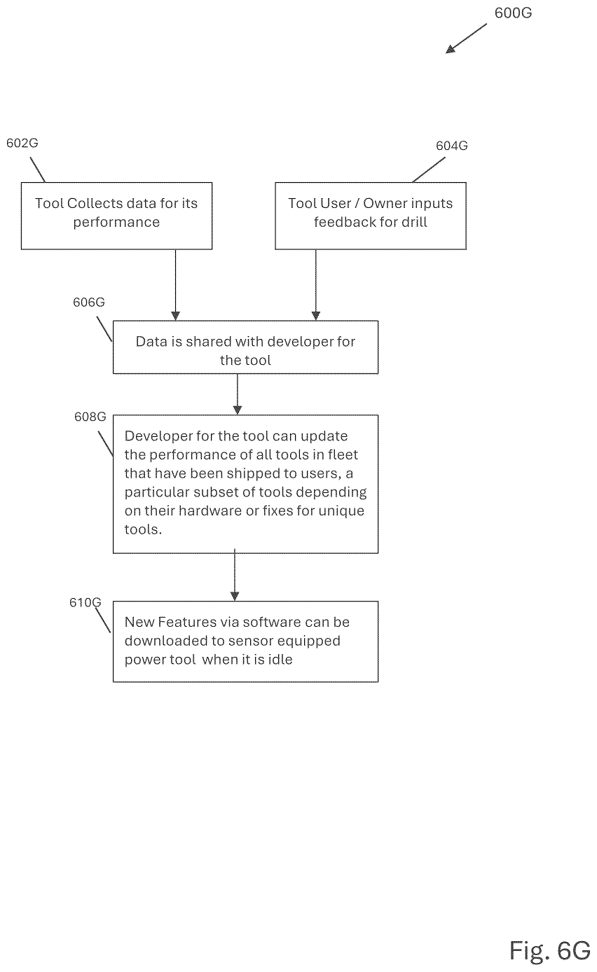

FIG. 6A illustrates one embodiment of a method 600A of operation of the sensor equipped power tool described in this disclosure. In a step 602A is provided activation and user selection of a tool tip or sensor detection of a part and automatic tool tip selection. In step 604A a movable engagement mechanism retrieves a tool bit from a tool tip holder. In step 606A the tool bit is moved by the engagement mechanism into a usable position. In step 608A a determination is made if a task is finished or if additional tool tips need to be used. If the task is finished, in step 610A the tool bit is moved by the movable engagement mechanism back into the tool tip holder. In step 612A, the movable engagement mechanism is moved back into a home position. If the task is not finished, the user can continue to use the activated tool, select a tool tip, or allow sensor detection of a part and automatic tool tip selection.

Other operations and control methods and actions can also be used in addition to or along with method 600A or other methods described in this disclosure. For example, available torque can be predicted and controlled at least in part based on sensor, material, or part data. For example, friction can be estimated using available data. Materials to be engaged with by a part held by a tool tip engagement mechanism can be detected or input by a user. Possible revolutions per minute (RPM), thread number and pitch on a bolt or screw can be available if the part is processed by a motor encoder. Finally, diameter of a bolt can be estimated knowing tool bit type and by sensing the part. Various control loop schemes can use this information along with the torque equation T=K×F×d, where Tis the torque, K is a constant that depends on the bolt material and size, F is axial bolt force, and d is nominal bolt diameter. Knowing K and d, a lookup table can be used to apply a known torque. If current is measured while torquing a bolt, the information can be used to update friction estimates, look up and update new K values, and adjust torque changes needed to compensate for lubrication or material changes. Further, the measured current (in particular, current spikes) can be used to determine when a part is fastened. Cross threading or other errors can be detected if the calculated torque range is outside of predetermined limits.

FIG. 6B illustrates one embodiment of a method 600B of operation of the sensor equipped power tool described in this disclosure. In this method is described an ability to automatically set the drilling/driving direction as clockwise or counterclockwise using computer vision, proximity sensors or any other sensors. The sensor or camera will evaluate if the bolt needs to be fastened or loosened, as well as a pre-set drilling direction. The user does not have to set the drilling direction as this is pre-set, but the user can override this if they desire. If bolt head is fastened then it likely needs to be loosened, set to loosen with automatic CCW turning. If bolt head is not fastened then set to clockwise rotation to tighten. While user override is allowed, a default should be what computer vision can determine is an intended action. If a bolt is partially fastened then a user can either loosen or tighten, and the control loop will use secondary inputs to determine the user's desired action. This could involve checking an assembly manual if the user is building (clockwise) or disassembling (counterclockwise) and the appropriate likely rotational direction as default, which can be modified via user input.

In a step 602B is provided use of camera used for computer-vision sensing that evaluates its field of vision. In step 604B computer vision processes and analyzes data, determining if the bolt is fastened, loose or partially fastened. Analysis occurs if threads on bolt can be seen, distance detected between bolt head and substrate and orientation of bolt relative to substrate, or there is detection of rotation between bolt and nut or bolt and substrate. In step 606B it is determined if the bolt is currently loose whether it is likely the user wants to tighten it. In step 608B rotation of driver clockwise to tighten can be set. Alternatively, in step 610B it can be determined if the bolt is currently partially tightened. The user might want to loosen it or tighten the bolt. In step 612B secondary inputs can be used to determine the user's desired action, check the assembly manual if the user is building or disassembling and set either clockwise or counterclockwise as the default. In some embodiments, if the user was in the process of tightening and pauses, the setting to tighten can be kept, unless as in step 618B user input is allowed to override default direction. In another alternative following from step 608B, in a step 614B it can be determined if the bolt is currently tightened and if it is likely the user wants to loosen it. In step 616B rotation of driver can be set counterclockwise to loosen, unless as in step 618B user input is allowed to override default direction.

FIG. 6C illustrates one embodiment of a method 600C of operation of the sensor equipped power tool described in this disclosure. This embodiment discloses a detailed method for detecting parts and providing a needed tool bit. In step 602C a camera used for computer-vision sensing evaluates its field of vision and determines screw head geometry and size. In step 604C the motor connected to the bit holder (structure which holds all bits/drivers) has position sensors, encoders, with a mapping table set to which encoder count corresponds to each bit. When the camera detects a bit head and geometry it requests this motor to position the corresponding bit/driver. In step 606C a motor connected to the bit holder drives the bit holder so the corresponding bit is positioned in line with the chuck mechanism. In step 608C a chuck mechanism is positioned such that chuck jaws can extend to grab the correct bit/driver. The actuator controlling the extension/retraction of the chuck jaws is programmed to know the diameter of the bit it is grabbing and therefore the extension needed to grab the bit. The motor calculates the rotations needed using encoders and position sensors and extends to grab the bit. It uses feedback via pulse width modulation and current spikes and measurement to determine once it has grabbed the bit/driver.

In step 610C a chuck mechanism translates/rotates out of the kinematic sweep of the remaining bits. The distance it needs to move away from the bits is controlled with position sensors in the motor translating or rotating the chuck. In step 612C a structure which holds all bits (bit holder) rotates out of position allowing the chuck to translate, rotate past it, making the driver/bit available for use. In step 614C a chuck which has the correct driver/bit is moved into a position where it usable by the user. In step 616C the driver/bit is powered by a motor or other actuator. Torque is delivered to the bolt head. In step 618C computer vision and feedback from motor or other actuator help provide ideal torque to loosen or tighten. Computer vision validates that the bit usage is complete.

In step 620C a user can place another bolt head geometry in field of sensor or camera vision. In step 622C the chuck and driver-bit are kept deployed and ready for use. In step 624C a user places another bolt head with same geometry in field of sensing. In step 626C the chuck is re-positioned so it can place the driver/bit in the bit holder structure which houses all bits. The bit holder rotates to the indexed position which corresponds to the bit which was used. The chuck places the bit into the bit holder housing and the actuator controlling the chuck jaws loosen. The next requested bit is positioned in front of the chuck so it can be grabbed. In step 628C the user powers off the system. In step 630C the chuck is re-positioned so it can place the driver/bit in the bit holder structure which houses all bits. The bit holder rotates to the indexed position which corresponds to the bit which was used. The chuck places the bit into the bit holder housing and the actuator controlling the chuck jaws loosen.

FIG. 6D illustrates one embodiment of a method 600D of operation of the sensor equipped power tool described in this disclosure. In this method is described a procedure for determining drilling mode or screw-driving mode. In instances where a screw head is not being sensed, the sensor equipped power tool can prioritize an ability to drill. If a screw head or bolt head is sensed the sensor equipped power tool deploys the exact geometry sensed. Size of drill bit to be deployed can also be determined.

In step 602D a camera used for computer-vision sensing evaluates its field of vision. In step 604D computer vision determines if a screw head or bolt head is sensed. In a first alternative, in step 606D it is determined with high confidence that no bolt head is in field of vision and a determination of the material being drilled into is made. In step 608D a screen, computer vision, phone application, website, mechanical switches or similar is used to choose the size of drill bit. Computer vision can help determine material and therefore if a specialized drill bit for wood, metal, plastic, drywall, composites, fiberglass, concrete, mortar, or grout, for example, needs to be used. In some embodiments a user can also use non-verbal visual signals with their fingers, for example holding one finger up for the smallest drill bit in storage, two fingers for the second smallest drill bit, three fingers for the third smallest drill bit and so on. Alternatively to step 606D, in step 610D a bolt head can be identified and bolt head geometry determined. In step 612D a corresponding driver for bolt head can be deployed, with torque and RPM profile set for the driver. As will be understood, both step 612D and 608D can be followed by step 614D, which allows for override of tool bit selection by a user.

FIG. 6E illustrates a method for using computer vision to determine diameter of the bolt, length of bolt, length of nut, or thread information to automatically drive a part at an ideal torque using a correct RPM profile. In step 602E a camera used for computer-vision sensing evaluates its field of vision. In step 604E the computer vision is used to determine the diameter of the bolt, length of bolt, length of nut or threads that need to be threaded. Also determinable is whether the screw is cutting threads in the substrate or existing threads exist and the material the bolt is being fastened into or loosened. In step 606E, Software or firmware in this tool can solve for:

Torque=K×Axial Bolt Force×bolt diameter
where K is a constant that depends on the bolt material and size and friction between materials. Current sensed by the motor powering the driver is proportional to friction so the device can adjust the torque and RPM based on the detected current. Initial assumptions for K can be estimated by evaluating materials and dimensions via computer vision and these assumptions can be re-evaluated with a feedback loop. A lookup table for axial forces needed can be referenced directly from what the manufacturer has set as the needed clamp force or preload or estimated via a lookup table for the bolt geometry and size evaluated. In step 608E, RPM profile can be set, relying on use of a feedback loop with the intent to start with a higher RPM to have the bolt snug and finally reduce RPM as it reaches desired clamp force to ensure precise control. The tool can estimate how quickly the threads are fastening using position sensors in a motor or other actuator driving the bit, proximity sensors, or computer vision. The software will correlate it to the current measured which is proportional to friction and modulate the torque, RPM & duty cycle to power the bit. The sensor equipped power tool can also note the torque applied and correlate it to what the manufacturer has suggested and common torque for bolts for this size, geometry engaging this material. If the torque value is outside bounds of threshold deviation, the tool has the ability to notify the user.

FIG. 6F illustrates one embodiment of a method 600F of operation of the sensor equipped power tool described in this disclosure. A sensor equipped power tool can be synchronized with a mobile app and/or cloud and connect with online communities, other builders and manufacturers of the product they are using the tool to build. Access instructions for a build can be found via the app, instructions can be uploaded via manufacturer, developer, online community or any other group/individual. The manufacturer/developer can pre-set the ideal torque and RPM that each bolt needs to be torqued at, and they can collect data from what the mechanical device actually used to learn and inform future customers. For large scale assembly lines, the assembly line can pre-program the tools for torque and RPM of each assembler and collect data on the devices torque usage.

In step 602F the sensor equipped power tool can have data synchronized with a mobile application. In step 604F, manufacturers of products that users assemble, other hobby builders/DIY, carpenters or developers can upload instructions to assemble products with pre-set torques, bits, and drivers to use. In step 606F, a mobile sync application and cloud or online communities can collectively gather real time data and instructions. In step 608F, a user can view an assembly manual via the mobile app. Details about the bits to be used and correct torque can be pre-programmed, always allowing a user to have a look and override settings if preferred. In step 610F, the sensor equipped power tool can apply correct torques, use correct tool bits, and identify screwdriver geometry and sizes. In step 612F, some or all operationally applied torques can be collected in a database if needed for future checks and tests, and data can be reviewed by manufacturers.

FIG. 6G illustrates one embodiment of a method 600G of operation of the sensor equipped power tool described in this disclosure. Remote software updates for the drill & tool to optimize performance using user submitted feedback and feedback via computer vision sensors on the device. The friction, assembly variation, environmental factors may vary from device to device & we want to be able to update the firmware on each device as it learns more about how the user uses it. General fixes and improvements can also be sent to the tool depending on developers intent. User feedback, or if tool used on an assembly line, the assemblers feedback can be used to tune the performance of the drill.

In a step 602G the sensor equipped power tool data is collected to track performance. In step 604G a user or owner of the sensor equipped power tool can input data. Data from both step 602G and 604G can be shared with a developer in step 606G. In step 608G the developer for the tool can update the performance of all tools in fleet that have been shipped to users, or update only a particular subset of tools depending on their hardware or fixes needed for unique tools. In step 610, new features can be added via software and downloaded to the sensor equipped power tool when is idle.

It will be understood that FIGS. 6A-6G and related detailed description and other disclosures herein illustrate steps of various embodiments of methods for operation of a sensor equipped power tool such as disclosed herein. This and other methods discussed herein can include any number of mechanical aspects and associated rules, which may be based on or otherwise configured in accordance with the purpose of and/or functions performed by a sensor equipped power tool such as described in this disclosure. Software features associated with the sensor equipped power tool may take the form of computer-executable instructions, such as program modules executable by computing components supported by the control system. Generally, program modules include routines, programs, objects, components, data structures, and/or the like configured to perform particular tasks or to implement particular abstract data types and may be encrypted. Furthermore, the functionality of the program modules may be combined or distributed as desired in various examples. Moreover, control scripts may be implemented in any suitable manner, such as in C/C++ or Python. The functionality of the program modules may be combined or distributed in various embodiments, including cloud-based implementations, web applications, or mobile applications for mobile devices.

Furthermore, certain aspects of the present technology can be embodied in a special purpose computer or data processor, such as application-specific integrated circuits (ASIC), digital signal processors (DSP), field-programmable gate arrays (FPGA), graphics processing units (GPU), many core processors, etc. specifically programmed, configured, or constructed to perform one or more computer-executable instructions. While aspects of the present technology, such as certain functions, may be described as being performed on a single device, these aspects, when suitable, can also be practiced in distributed computing environments where functions or modules are shared among different processing devices linked through a communications network such as a Local Area Network (LAN), Wide Area Network (WAN), or the Internet. In a distributed computing environment, program modules and other components may be located in both local and remote memory storage and other devices, which may be in communication via one or more wired and/or wireless communication channels.

Aspects of the present technology may be stored or distributed on tangible computer-readable media, which can include volatile and/or non-volatile storage components, such as magnetically or optically readable computer media, hard-wired or preprogrammed chips (e.g., EEPROM semiconductor chips), nanotechnology memory, biological memory, or other computer-readable storage media. Alternatively, computer-implemented instructions, data structures, screen displays, and other data under aspects of the present technology may be distributed (encrypted or otherwise) over the Internet or over other networks (including wireless networks), on a propagated signal on a propagation medium (e.g., electromagnetic wave(s), sound wave, etc.) over a period of time, or they may be provided on any analog or digital network (packet switched, circuit switched, or other scheme). Furthermore, the term computer-readable storage medium does not encompass signals (e.g., propagating signals) or transitory media. One of ordinary skill in the art will recognize that various components of the sensor equipped power tool may communicate via any number of wired and/or wireless communication techniques. Additionally, elements of the sensor equipped power tool may be distributed rather than located in a single monolithic entity. Accordingly, the disclosed systems and techniques may operate in one or more examples other than the examples provided above.

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown or described in detail to avoid unnecessarily obscuring the description of the embodiments of the present technology. Although steps of methods may be presented herein in a particular order, in alternative embodiments the steps may have another suitable order. Similarly, certain aspects of the present technology disclosed in the context of particular embodiments can be combined or eliminated in other embodiments. Furthermore, while advantages associated with certain embodiments may be disclosed herein in the context of those embodiments, other embodiments may also exhibit such advantages, and not all embodiments need necessarily exhibit such advantages or other advantages disclosed herein to fall within the scope of the present technology. This disclosure and the associated technology can encompass other embodiments not expressly shown or described herein.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Any reference herein to “the inventors” means at least one inventor of the present technology. As used herein, the terms “generally,” “substantially,” “about,” and similar terms are used as terms of approximation and not as terms of degree, and are intended to account for the inherent variations in measured or calculated values that would be recognized by those of ordinary skill in the art. Additionally, the terms “comprising,” “including,” “having,” and the like as used herein mean including at least the recited feature(s) such that any greater number of the same feature(s) and/or one or more additional types of features are not precluded. This is the case even if a particular number of features is specified unless that specified number is preceded by the word “exactly” or another clear indication that it is intended to be closed ended.

Directional terms, such as “upper,” “lower,” “front,” “back,” “vertical,” and “horizontal,” may be used herein to express and clarify the relationship between various structures. It should be understood that such terms do not denote absolute orientation. Reference herein to “one embodiment,” “an embodiment,” or similar phrases means that a particular feature, structure, or operation described in connection with such phrases can be included in at least one embodiment of the present technology. Thus, such phrases as used herein are not all referring to the same embodiment. Unless preceded with the word “conventional,” reference herein to “counterpart” devices, systems, methods, features, structures, or operations refers to devices, systems, methods, features, structures, or operations in accordance with at least some embodiments of the present technology that are similar to a described device, system, method, feature, structure, or operation in certain respects and different in other respects. Finally, it should be noted that various particular features, structures, and operations of the embodiments described herein may be combined in any suitable manner in additional embodiments in accordance with the present technology.

I claim:

1. A sensor equipped power tool, comprising
a housing;
a movable engagement mechanism supported by the housing and movable between a first and a second position;
a tool bit holder able to support a plurality of tool bits, with each tool bit individually engageable by the movable engagement mechanism in a first position; and
a sensor able to provide information to a control system, with the control system guiding selection and engagement of a tool bit by the movable engagement mechanism and moving the movable engagement mechanism into the second position to allow engagement of the tool bit with potentially engageable parts.

2. The sensor equipped power tool of claim 1, wherein the housing defines a pistol grip.

3. The sensor equipped power tool of claim 1, wherein the movable engagement mechanism is linearly movable.

4. The sensor equipped power tool of claim 1, wherein the movable engagement mechanism is rotationally movable.

5. The sensor equipped power tool of claim 1, wherein the tool bit holder is a rotatable plate.

6. The sensor equipped power tool of claim 1, wherein the tool bit holder can hold at least one of a screw bit and a drill bit.

7. The sensor equipped power tool of claim 1, wherein the sensor is supported by the housing.

8. The sensor equipped power tool of claim 1, wherein the sensor is a camera positioned to detect potentially engageable parts.

9. The sensor equipped power tool of claim 1, wherein the sensor is a camera positioned to detect construction materials.

10. A method of operating a sensor equipped power tool, comprising the steps of using sensor information to determine engageable parts geometry and aid selection of a corresponding tool bit;
moving a tool bit holder to a position allowing engagement of a tool bit by the movable engagement mechanism; and
moving the tool bit holder to another position allowing use of the tool bit.

11. A method of operating a sensor equipped power tool of claim 10, further comprising the step of setting torque profile.

12. A method of operating a sensor equipped power tool of claim 10, further comprising the steps of determining likely torque applied by the tool bit to a part, and adjusting applied torque as the part is driven into material.

13. A method of operating a sensor equipped power tool of claim 10, further comprising the steps of using on computation supported by the sensor equipped power tool to determine torque profile, rotation direction, speed profile, drilling depth or downloading data related to operation of the sensor equipped power tool, and using downloaded data relevant to assembly to set at least one of tool bit selection and applied torque, speed, and drilling depth.

14. A method of operating a sensor equipped power tool of claim 10, further comprising the steps of collecting data related to user operation of the sensor equipped power tool from at least one of users to users, manufacturers to users, and users to manufacturers, and sharing at least some user operational data with others.

15. A method of operating a sensor equipped power tool, comprising moving a tool bit holder to a position allowing engagement of a tool bit by the movable engagement mechanism;
moving the tool bit holder to another position allowing use of the tool bit; and
using sensor information and feedback to adjust rotation applied to the tool bit, with one of clockwise and counterclockwise being selected.

16. A method of operating a sensor equipped power tool of claim 15, further comprising the step of using sensor information to determine engageable parts geometry and aid selection of a corresponding tool bit.

17. A method of operating a sensor equipped power tool of claim 15, further comprising the step of using an encoder and mapping table to determine a particular tool tip position.

18. A method of operating a sensor equipped power tool of claim 15, further comprising the step of linearly moving the movable engagement mechanism.

19. A method of operating a sensor equipped power tool of claim 15, further comprising the step of rotationally moving the movable engagement mechanism.

20. A method of operating a sensor equipped power tool of claim 15, further comprising the steps of determining material characteristics to assist in drill selection, selecting a tool bit based on detected part characteristics, and setting torque profile based on material and detected part characteristics.
